(19) United States
(12) Patent Application Publication
(10) Pub. No.: US 2025/0131417 A1
(43) Pub. Date: Apr. 24, 2025

(54) DETECTING SOCIAL ENGINEERING ATTACKS USING A MACHINE LEARNING MODEL TRAINED ON OUTPUT FROM GENERATIVE ARTIFICIAL INTELLIGENCE

(71) Applicant: Capital One Services, LLC, McLean, VA (US)

(72) Inventors: Nathan Wolfe, Silver Spring, MD (US); Joshua Edwards, Philadelphia, PA (US); Benjamin Eng, Silver Spring, MD (US)

(21) Appl. No.: 18/383,126

(22) Filed: Oct. 24, 2023

(51) Int. Cl. G06Q 20/38; G06F 40/35; H04L 9/40; H04L 51/02

(52) U.S. Cl. CPC G06Q 20/3821; G06F 40/35; H04L 51/02; H04L 63/1483

(57) ABSTRACT

The present disclosure describes a machine learning model trained to identify social engineering attacks. A prompt may be provided to a generative artificial intelligence to create communications resembling social engineering attacks. The communications may be inputted into a machine learning model to train the machine learning model to identify social engineering attacks. The machine learning model may also be trained on actual social engineering attacks. Once trained, the machine learning model may be deployed to monitor a plurality of communication channels to detect social engineering attacks. Upon detecting a social engineering attack, a system may implement one or more remedial actions to mitigate the detected social engineering attack.

### FIELD OF THE INVENTION

Aspects of the disclosure generally relate to detecting social engineering attacks and, more specifically, to training a machine learning model to detect social engineering attacks using data generated by a generative artificial intelligence.

### BACKGROUND OF THE INVENTION

Many steps are taken to protect networks from cyberattacks. While intrusion detection systems, firewalls, and other devices are capable of scanning and analyzing traffic to mitigate cyberattacks, these devices have difficulties protecting against social engineering attacks. Social engineering attacks are a broad range of malicious activities designed to trick a user (or multiple users) into committing a security mistake and/or divulging confidential or sensitive information. Existing cybersecurity solutions do not provide protections around user communications and, therefore, have a difficult time mitigating social engineering attacks. Moreover, the rise of generative artificial intelligence and the increase in quality and availability of generative artificial intelligence provides malicious actors with the ability to create a bot that sounds authentic (e.g., human-like) and that would follow a series of steps in an attempt to social engineer agents and/or chatbots. Indeed, the use of AI-backed chatbots has significantly increased, both in chat-based interactions, as well as call center interactions. Accordingly, there is a need to protect against social engineering attacks and/or AI-backed social engineering attacks.

### SUMMARY OF THE INVENTION

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may relate to detecting social engineering attacks. Further aspects may also include training a machine learning model to detect social engineering attacks using data generated by a generative artificial intelligence.

The present disclosure discloses techniques for training one or more machine learning models to identify communications resembling social engineering attacks. According to one or more aspects of the disclosure, a prompt may be provided to a generative artificial intelligence. The prompt may ask the generative artificial intelligence to generate one or more communications associated with, or resembling, a social engineering attack. In response to the prompt, one or more communications associated with, or resembling, a social engineering attack may be received from the generative artificial intelligence. The one or more communications may be inputted into a machine learning model to train the machine learning model to identify (e.g., detect) social engineering attacks. According to some aspects of the disclosure, prior social engineering attacks, or prior attempts at social engineering, may also be inputted into the machine learning model as part of the training process. Once the machine learning model is trained to identify (e.g., detect) social engineering attacks, the trained machine learning model may be deployed, for example, as part of a monitoring system (e.g., network intrusion detection system).

The monitoring system, with the trained machine learning model, may monitor one or more communication channels. Preferably, the monitoring system passively monitors (e.g., listens) to the one or more communication channels. The monitoring system may use one or more application programming interfaces (APIs) to monitor the one or more communication channels. Based on monitoring the one or more communication channels and using the trained machine learning model, the monitoring system may detect a social engineering attack in one or more communications. Detecting the social engineering attack may include calculating a probability (e.g., a risk score) that the one or more communications are a social engineering attack. If the probability satisfies a threshold, the monitoring system may determine that the one or more communications are a social engineering attack. Based on detecting the social engineering attack, the monitoring system may perform one or more remedial actions to mitigate the social engineering attack. For example, the monitoring system may redirect an attacker to an agent, for example, when the target is a chatbot. In another example, the monitoring system may cause a notification to be displayed to an agent, for example, when the agent is the target of a social engineering attack. In other examples, the monitoring system may implement additional security measures and/or safeguards when a user is the target of a social engineering attack. In some instances, multifactor authentication may be implemented, for example, when a user is the target of a social engineering attack. Multifactor authentication may be implemented, for example, when a user attempts to login to their account via a website or a mobile application. Multifactor authentication may also be implemented, for example, when a user attempts to perform a transaction.

These features, along with many others, are discussed in greater detail below.

### BRIEF DESCRIPTION OF DRAWINGS

The present disclosure is illustrated by way of example and not limited in the accompanying figures in which like reference numerals indicate similar elements and in which:

FIGS. 1A and 1B show an example of a system in which one or more features described herein may be implemented;

FIG. 2 shows an example computing device in accordance with one or more aspects of the disclosure;

FIG. 3 shows an example of a process for training a machine learning model to identify one or more social engineering attacks in accordance with one or more aspects of the disclosure; and

FIG. 4 shows an example of a process for monitoring one or more communication channels to detect social engineering attacks in accordance with one or more aspects of the disclosure.

### DETAILED DESCRIPTION OF THE INVENTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

As noted above, there are several solutions designed to protect networks from cyberattacks. However, human interactions and software designed to imitate human interactions (e.g., chatbots) are often a vulnerability that are difficult to protect against. In this regard, both humans and chatbots are susceptible to social engineering attacks, which are attacks specifically designed to trick a target into committing a security mistake and/or disclosing confidential or sensitive information. Existing cybersecurity solutions do not provide protections around user communications and, therefore, have a difficult time mitigating social engineering attacks. Moreover, cybersecurity solutions that attempt to guard against social engineering attacks have a difficult time doing so due, in part, to computer's difficulties in comprehending dialogue. This is further compounded by the rise of generative artificial intelligence. Using generative artificial intelligence, malicious actors have the ability to create a bot that sounds authentic (e.g., human-like) and that would follow a series of steps in an attempt to social engineer agents and/or chatbots.

By way of introduction, aspects described herein may relate to training a machine learning model to identify social engineering attacks in one or more communications. By improving a computer and/or machine learning model's comprehension of a dialogue, the present disclosure may improve a computer and/or machine learning model's ability to detect social engineering attacks. These improvements are realized, in part, by using training data generated by a generative artificial intelligence model. A prompt may be provided to a generative artificial intelligence. The prompt may ask the generative artificial intelligence to generate one or more communications associated with, or resembling, a social engineering attack. In response to the prompt, one or more communications associated with, or resembling, a social engineering attack may be received from the generative artificial intelligence. The one or more communications received from the generative artificial intelligence may be inputted into a machine learning model. The one or more communications may be used to train the machine learning model to identify (e.g., detect) social engineering attacks. In addition to the one or more communications generated by the generative artificial intelligence, prior social engineering attacks, or prior attempts at social engineering, may also be inputted into the machine learning model as part of the training process. The combination of generated and real-world training data improves the machine learning model's ability to identify (e.g., detect) social engineering attacks. Further, the use of both generated and real-world training data improves the machine learning model's ability to recognize social engineering attacks generated by a bot using generative artificial intelligence.

Once the machine learning model is trained to identify (e.g., detect) social engineering attacks, the trained machine learning model may be deployed, for example, as part of a monitoring system (e.g., network intrusion detection system). The monitoring system, with the trained machine learning model, may passively monitor (e.g., listen to) one or more communication channels, for example, via one or more APIs. Based on monitoring the one or more communication channels and using the trained machine learning model, the monitoring system may identify one or more communications that resemble a social engineering attack. The one or more communications resembling a social engineering attack may be analyzed to determine a probability (e.g., a risk score) that the one or more communications are a social engineering attack. If the probability satisfies a threshold, the monitoring system may determine that the one or more communications are a social engineering attack. Based on detecting the social engineering attack, one or more remedial actions may be undertaken to mitigate the social engineering attack. By using the trained machine learning model, cybersecurity may be improved by adding an additional layer of protection to an often overlooked and vulnerable segment of cyber security. Moreover, the trained machine learning model addresses problems rooted in computer technology, namely-cyberattacks perpetrated via chat interactions. The trained machine learning model described herein provides an additional, unconventional solution to further secure network infrastructure from cyberattacks.

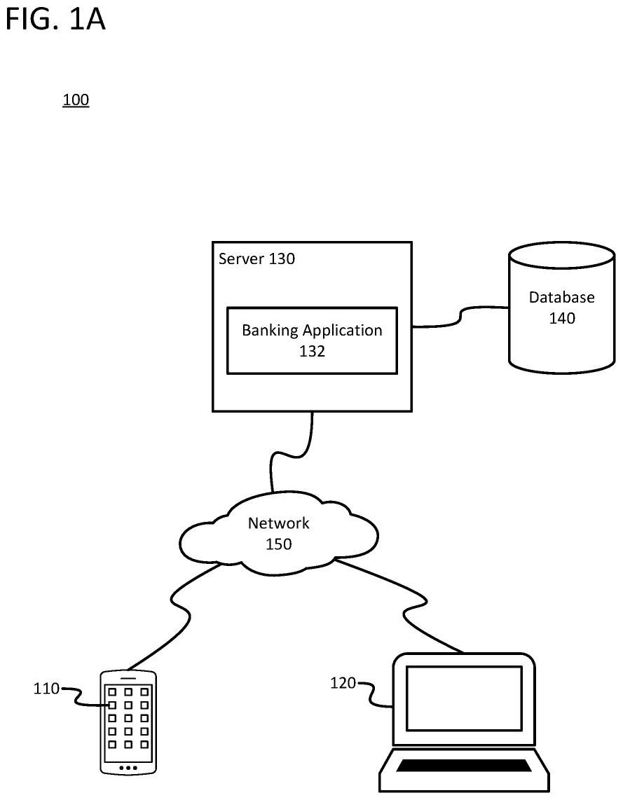

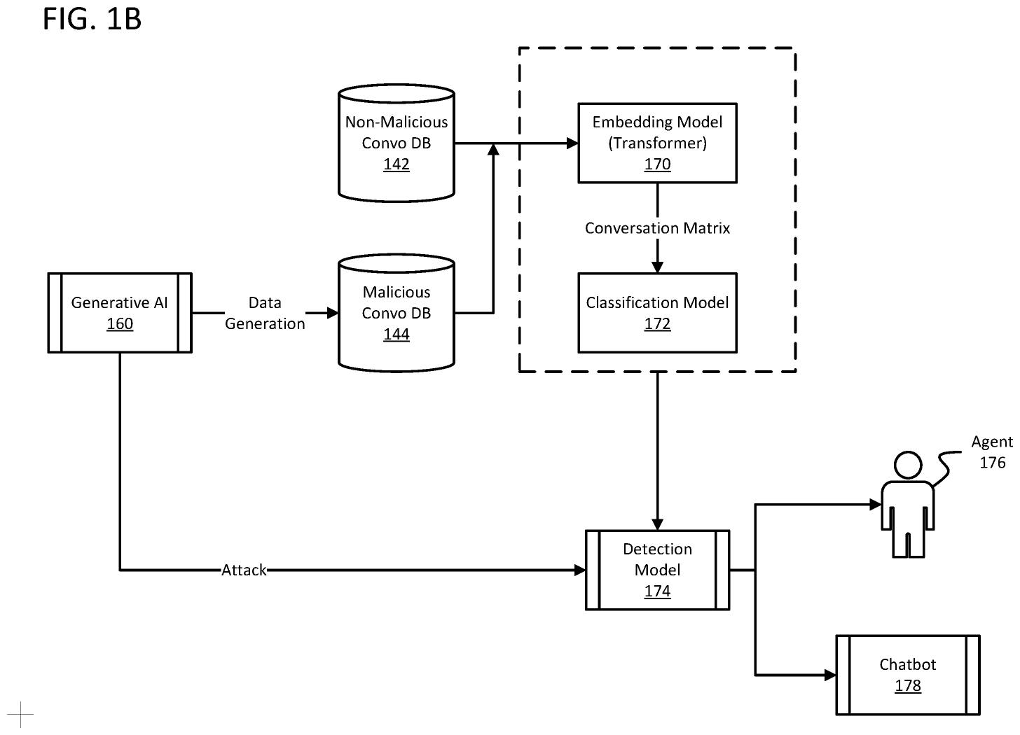

FIG. 1A shows an example of a system 100 that includes a first user device 110, a second user device 120, and a server 130, connected to a database 140, interconnected via network 150.

First user device 110 may be a mobile device, such as a cellular phone, a mobile phone, a smart phone, a tablet, a laptop, or an equivalent thereof. First user device 110 may provide a first user with access to various applications and services. For example, first user device 110 may provide the first user with access to the Internet. Additionally, first user device 110 may provide the first user with one or more applications (“apps”) located thereon. The one or more applications may provide the first user with a plurality of tools and access to a variety of services. In some embodiments, the one or more applications may include a banking application that provides access to the first user's banking information, as well as perform routine banking functions, such as checking the first user's balance, paying bills, transferring money between accounts, withdrawing money from an automated teller machine (ATM), and wire transfers. The banking application may comprise an authentication process to verify (e.g., authenticate) the identity of the first user prior to granting access to the banking information.

Second user device 120 may be a computing device configured to allow a user to execute software for a variety of purposes. Second user device 120 may belong to the first user that accesses first user device 110, or, alternatively, second user device 120 may belong to a second user, different from the first user. Second user device 120 may be a desktop computer, laptop computer, or, alternatively, a virtual computer. The software of second user device 120 may include one or more web browsers that provide access to websites on the Internet. These websites may include banking websites that allow the user to access his/her banking information and perform routine banking functions. In some embodiments, second user device 120 may include a banking application that allows the user to access his/her banking information and perform routine banking functions. The banking website and/or the banking application may comprise an authentication component to verify (e.g., authenticate) the identity of the second user prior to granting access to the banking information.

Server 130 may be any server capable of executing banking application 132. Additionally, server 130 may be communicatively coupled to database 140. In this regard, server 130 may be a stand-alone server, a corporate server, or a server located in a server farm or cloud-computer environment. According to some examples, server 130 may be a virtual server hosted on hardware capable of supporting a plurality of virtual servers.

Banking application 132 may be server-based software configured to provide users with access to their account information and perform routing banking functions. In some embodiments, banking application 132 may be the server-based software that corresponds to the client-based software executing on first user device 110 and second user device 120. Additionally, or alternatively, banking application 132 may provide users access to their account information through a website accessed by first user device 110 or second user device 120 via network 150. The banking application 132 may comprise an authentication module to verify users before granting access to their banking information. Additionally or alternatively, banking application 132 may comprise an automated customer service solution, such as a chatbot or an automated answering service.

Database 140 may be configured to store information on behalf of application 132. The information may include, but is not limited to, personal information, account information, and user-preferences. Personal information may include a user's name, address, phone number (i.e., mobile number, home number, business number, etc.), social security number, username, password, employment information, family information, and any other information that may be used to identify the first user. Account information may include account balances, bill pay information, direct deposit information, wire transfer information, statements, and the like. User-preferences may define how users receive notifications and alerts, spending notifications, and the like. Additionally or alternatively, database 140 may store a plurality of multi-party dialogues, including, for examples, recorded conversations between a customer and a service agent, transcribed conversations, interactions between a customer and a chatbot, etc. Database 140 may include, but are not limited to relational databases, hierarchical databases, distributed databases, in-memory databases, flat file databases, XML databases, NoSQL databases, graph databases, and/or a combination thereof.

Network 150 may include any type of network. In this regard, network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

FIG. 1B shows an example of a machine learning model configured to detect (e.g., identify) social engineering attacks. As discussed in greater detail below, generative artificial intelligence 160 may receive one or more prompts (e.g., requests) to generate communications associated with, or resembling, social engineering attacks. Generative artificial intelligence model 160 may be a publicly-available generative artificial intelligence, such as ChatGPT, Bard, M365 Copilot, Scribe, Jasper, etc. In response to the prompt, generative artificial intelligence model 160 may generate (e.g., create, derive, etc.) one or more communications associated with, or resembling, social engineering attacks. Generative artificial intelligence model 160 may provide the one or more communications associated with, or resembling, social engineering attacks to the requesting party. The requesting party may receive the one or more communications associated with, or resembling, social engineering attacks from generative artificial intelligence model 160. The one or more communications associated with, or resembling, social engineering attacks may be stored, for example, in a database, such as malicious conversation database 144. In this regard, the requesting party may have a database of non-malicious conversations (e.g., non-malicious conversation database 142) and malicious conversation database 144. Non-malicious conversation database 142 and malicious conversation database 144 may be part of the same database, such as database 140 discussed above. Alternatively, non-malicious conversation database 142 and malicious conversation database 144 may be separate databases. As the names imply, non-malicious conversation database 142 may be configured to store one or more first communications that were not identified as malicious and/or social engineering attacks; whereas, malicious conversation database 144 is configured to one or more second communications that were identified as malicious and/or social engineering attacks. A training dataset may be prepared from the one or more first communications and the one or more second communications. The training dataset may be provided to embedding model 170. Embedding model 170 may comprise a transformer-based machine learning model configured to generate one or more embeddings that form a conversation matrix. The conversation matrix may be provided to classification model 172, which may be configured to identify communications associated with social engineering attacks, as well as communications that are not associated with social engineering attacks. Classification model 172 may be a neural network, such as a recurrent neural network or a recursive neural network. The machine learning model, and in particular—classification model 172, may be trained until convergence (i.e., an error range with an acceptable tolerance) is achieved. After convergence is realized, embedding model 170 and classification model 172 may be deployed as detection model 174. As discussed in greater detail below, detection model 174 may monitor one or more communication channels to detect (e.g., identify) communications associated with, or resembling, social engineering attacks. As shown in FIG. 1B, detection model 174 may monitor communications with agent 176 and chatbot 178. As discussed further below, detection model 174 may implement one or more remedial actions, for example, based on detecting (e.g., identifying) a social engineering attack in the communications with either agent 176 and/or chatbot 178.

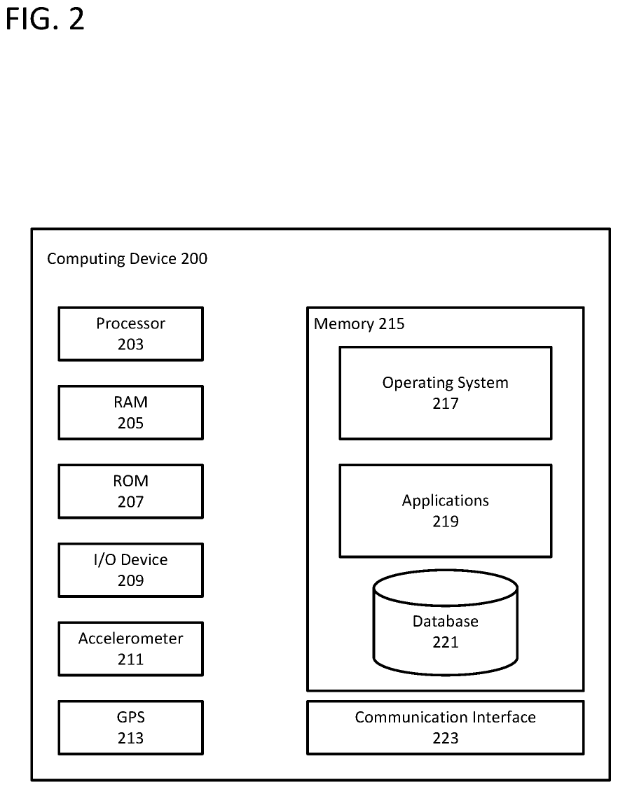

Any of the devices and systems described herein may be implemented, in whole or in part, using one or more computing devices described with respect to FIG. 2. Turning now to FIG. 2, a computing device 200 that may be used with one or more of the computational systems is described. The computing device 200 may comprise a processor 203 for controlling overall operation of the computing device 200 and its associated components, including RAM 205, ROM 207, input/output device 209, accelerometer 211, global-position system antenna 213, memory 215, and/or communication interface 223. A bus 202 may interconnect processor(s) 203, RAM 205, ROM 207, memory 215, I/O device 209, accelerometer 211, global-position system receiver/antenna 213, memory 215, and/or communication interface 223. Computing device 200 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Input/output (I/O) device 209 may comprise a microphone, keypad, touch screen, and/or stylus through which a user of the computing device 200 may provide input, and may also comprise one or more speakers for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may comprise volatile and nonvolatile, removable and non-removable media implemented in any method or technology for storage of information such as computer-readable instructions, data structures, program modules, or other data. Memory 215 may comprise one or more physical persistent memory devices and/or one or more non-persistent memory devices. Memory 215 may comprise random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user.

Communication interface 223 may comprise one or more transceivers, digital signal processors, and/or additional circuitry and software, protocol stack, and/or network stack for communicating via any network, wired or wireless, using any protocol as described herein.

Processor 203 may comprise a single central processing unit (CPU), which may be a single-core or multi-core processor, or may comprise multiple CPUs. Processor(s) 203 and associated components may allow the computing device 200 to execute a series of computer-readable instructions (e.g., instructions stored in RAM 205, ROM 207, memory 215, and/or other memory of computing device 215, and/or in other memory) to perform some or all of the processes described herein. Although not shown in FIG. 2, various elements within memory 215 or other components in computing device 200, may comprise one or more caches, for example, CPU caches used by the processor 203, page caches used by the operating system 217, disk caches of a hard drive, and/or database caches used to cache content from database 221. A CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

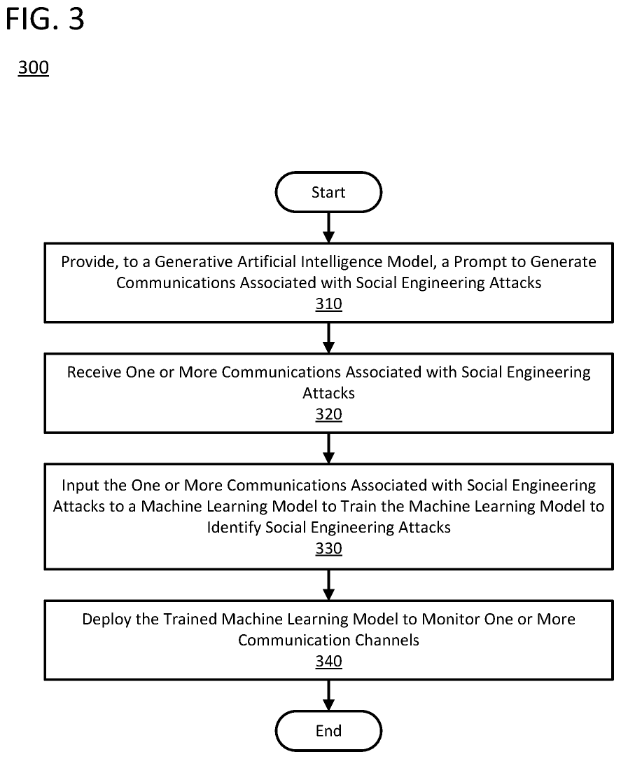

FIG. 3 shows a flow chart of a process for training a machine learning model to identify one or more social engineering attacks according to one or more aspects of the disclosure. Some or all of the steps of process 300 may be performed using one or more computing devices as described herein, including, for example, the first user device 110, the second user device 120, the server 130, the computing device 200, or any combination thereof.

In step 310, a prompt (e.g., request) to generate communications associated with social engineering attacks may be provided to a generative artificial intelligence model. The prompt may comprise a natural language prompt. For example, the prompt may be: “generate spear phishing emails” or “generate phishing communications.” In some examples, the prompt may comprise one or more Boolean operators. For instance, the prompt may comprise: “phishing AND communications.” In further examples, the prompt may specify the type of communications, such as text-based communications, emails, audio communications (e.g., phone calls), video communications (e.g., conference calls, etc.). The generative artificial intelligence model may be a publicly-available generative artificial intelligence model, such as ChatGPT, Bard, M365 Copilot, Scribe, Jasper, etc. Additionally or alternatively, the generative artificial intelligence model may be a propriety generative artificial intelligence model. The propriety generative artificial intelligence model may be trained to generate communications that resemble social engineering attacks. The propriety generative artificial intelligence model may be trained using supervised learning, unsupervised learning, back propagation, transfer learning, stochastic gradient descent, learning rate decay, dropout, max pooling, batch normalization, long short-term memory, skip-gram, or any equivalent deep learning technique. The dataset used to train the propriety generative artificial intelligence model may comprise prior social engineering attacks and/or attempts at social engineering attacks, including, for example, exchanges between an attacker and a chatbot, spear phishing emails, conversations between an attacker and a customer service representative, etc. In some examples, a combination of publicly-available generative artificial intelligence models, propriety generative artificial intelligence models, and/or prior social engineering attacks and/or attempts at social engineering attacks may be used as a dataset to train the machine learning model to identify social engineering attacks.

In step 320, the communications resembling social engineering attacks may be received from the generative artificial intelligence model. As noted above, the communications may be received as at least one of one or more text files, one or more audio files, or one or more video files. The one or more text files may comprise text exchanges between an attacker and a chatbot. Additionally or alternatively, the one or more text files may comprise emails associated with social engineering attacks or examples of inserting malicious code into a database. The one or more audio files may comprise one or more telephone calls (e.g., conversations) between an attacker and a customer service representative. Similarly, the one or more video files may comprise one or more conference calls between an attacker and one or more targets of a social engineering attack.

In some instances, the communications resembling the social engineering attacks may be normalized, for example, prior to being inputted into the machine learning model. Normalizing the communications may comprise a variety of different techniques for each of the different file types received from the generative artificial intelligence model. In the context of the one or more text files, normalization may comprise removing formatting and/or special characters. Normalization of the text file may also comprise converting the file from a first format to a second format. For example, a text file may be converted to a JSON or a CSV file, or vice versa. In the context of the one or more audio and/or video files, normalization may comprise transcribing the audio of the files, for example, using natural language processing or speech-to-text analysis. The transcriptions may then be normalized using similar techniques to those discussed above with respect to the one or more text files.

In step 330, the communications resembling social engineering attacks may be inputted into a machine learning model to train the machine learning model to identify social engineering attacks, such as phishing, spear phishing, baiting, malware, pretexting, quid pro quo, vishing, water-holing, etc. The machine learning model may be a neural network, such as a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or any equivalent thereof. Additionally or alternatively, the machine learning model may comprise one or more decision trees. The machine learning model may be trained using supervised learning, unsupervised learning, back propagation, transfer learning, Adam stochastic optimization, stochastic gradient descent, learning rate decay, dropout, max pooling, batch normalization, long short-term memory, skip-gram, or any equivalent deep learning technique. Preferably, the model is trained using supervised learning with a cross entropy minimizing loss function using some gradient optimization. In other preferred examples, the model is trained using self-supervised learning (e.g., contrastive learning) to decouple the embedding spaces of the negative and positive examples. The machine learning model may be trained, for example, using one or more conversations, exchanges, and/or prompts generated by a generative artificial intelligence. Additionally or alternatively, the machine learning model may be trained using prior attempts at social engineering. That is, prior social engineering attacks, such as exchanges between an attacker and a chatbot, spear phishing emails, conversations between an attacker and a customer service representative, etc., may be stored in a database, such as database 140. The prior social engineering attacks may be used to train the machine learning model. For example, the corpus of prior social engineering attacks may be divided into training data and testing data. Preferably, 65% to 85% of the corpus would form the training data, while the remaining 15% to 35% of the corpus would be test data. The machine learning model may be trained using the training data, while the test data would be used to help the machine learning model achieve convergence (i.e., an error range with an acceptable tolerance).

In step 340, the trained machine learning model may be deployed. Deploying the trained machine learning model may comprise allowing the trained machine learning model to passively monitor one or more communication channels, such as chatbot conversations, emails, telephone calls, video conferences, etc. In this regard, the trained machine learning model may be incorporated in a monitoring system, such as a data loss prevention system. The monitoring system may comprise one or more application programming interfaces (APIs) that allow the monitoring system to access the one or more communication channels to monitor for social engineering attacks. After being deployed, the trained machine learning model may monitor (e.g., listen) to the one or more communication channels to detect and/or identify social engineering attacks. In this regard, the trained machine learning model may have a sliding window of exchanges (e.g., the last five (5) exchanges, the last ten (10) exchanges, etc.) to monitor.

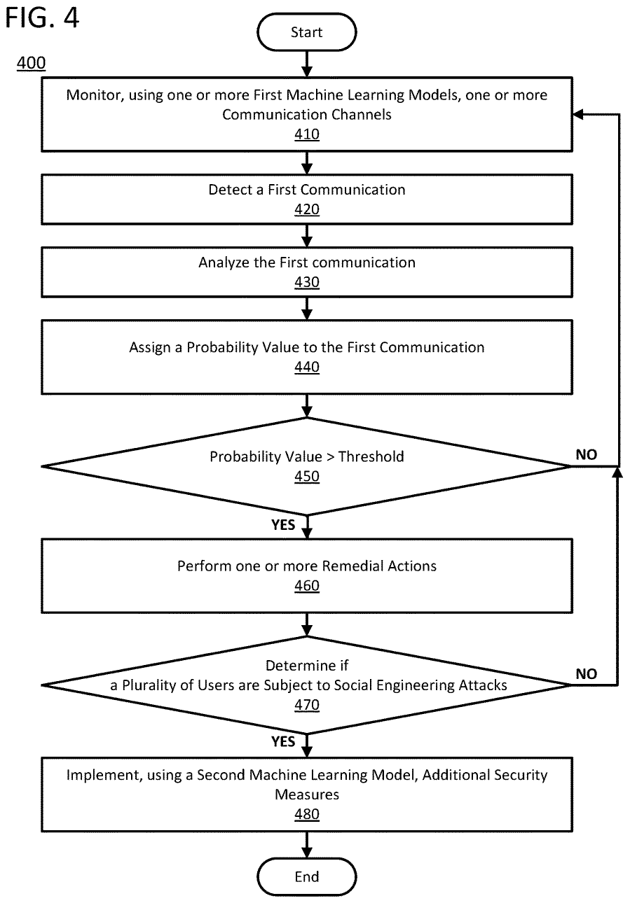

FIG. 4 shows a flow chart of a process for monitoring one or more communication channels to detect social engineering attacks according to one or more aspects of the disclosure. Some or all of the steps of process 400 may be performed using one or more computing devices as described herein, including, for example, the first user device 110, the second user device 120, the server 130, the computing device 200, or any combination thereof.

In step 410, one or more communication channels may be monitored, for example, using the trained machine learning model. As noted above, the one or more communication channels comprise at least one of conversations with a chatbot, email exchanges, telephone calls, video conferences, etc. The trained machine learning model may be a component of a monitoring system, such as a data loss prevention system. The trained machine learning model may use one or more APIs to passively monitor (e.g., listen) to the one or more communication channels to detect and/or identify social engineering attacks. The trained machine learning model may monitor a sliding window of exchanges (e.g., the last five (5) exchanges, the last ten (10) exchanges, etc.) to detect and/or identify social engineering attacks.

In step 420, the monitoring system may detect a first communication of one or more communications. The first communication may comprise a social engineering attack, such as phishing, spear phishing, baiting, malware, pretexting, quid pro quo, vishing, water-holing, etc. In some examples, the first communication may comprise a plurality of exchanges and/or messages. In this regard, the monitoring system may monitor a sliding (e.g., rolling) window of a conversation between a customer/attack and an entity, such as a chatbot or agent.

In step 430, the monitoring system may analyze the first communication. Analyzing the first communication may comprise generating an embedding for each snippet of a conversation. The embeddings may be generated using an embedder, such as bidirectional encoder representations from transformers (BERT). In some instances, the analysis may generate a sequence of embeddings. The sequence of embeddings may be inputted into the trained machine learning model.

In step 440, the monitoring system (e.g., the trained machine learning model) may assign a probability (e.g., risk score) to the first communication. That is, the monitoring system may assign a probability to each embedding in a sequence of embeddings. Additionally or alternatively, the monitoring system may assign a probability to an entire sequence of embeddings. The probability value may indicate a likelihood that the first communication comprises a social engineering attack. In other words, the monitor system (e.g., the trained machine learning model) may calculate a probability that the first communication (e.g., one or more embeddings, a sequence of embeddings, etc.) is a social engineering attack. The probability may be assigned (e.g., calculated), for example, based on the first communication (e.g., one or more embeddings, a sequence of embeddings, etc.) being similar to, or matching, a known social engineering attack. Additionally or alternatively, the probability may be assigned (e.g., calculated), for example, heuristically based on unusual activity. For example, the monitoring system may determine a geographic location from which the first communication originated. The probability may be assigned (e.g., calculated), for example, based on the geographic location from which the first communication originated. In another example, the monitoring system may determine that the first communication is associated with a first account. The monitoring system may further determine whether a request for a transaction outside of a geographic location associated with the first account has been received. The probability may be assigned (e.g., calculated), for example, based on a determination that the request for the transaction was received from outside of a geographic location associated with the first account. The probability may be assigned (e.g., calculated), for example, based on the type of social engineering attack. Additionally or alternatively, the probability may be assigned (e.g., calculated), for example, based on the type of information (e.g., account takeover, password information, etc.) being sought via the social engineering attack. It will be appreciated that any of the factors discussed above may be used individually or in combination to determine a probability that the first communication comprises a social engineering attack.

In step 450, the monitoring system may determine whether the probability satisfies a threshold. If the probability is less than the threshold, the monitoring system may determine that it is unlikely that the first communication is a social engineering attack. The monitoring system may return to step 410, and the process 400 may repeat. In this regard, process 400 repeating may include evaluating additional communications that have subsequently been received. The first communication in combination with the additional communications may satisfy the threshold. When the probability satisfies the threshold (e.g., is greater than or equal to the threshold), the monitoring system may determine that the first communication is a first social engineering attack and the monitoring system may proceed to step 460. based on a determination that the probability value exceeds a threshold, identifying the first communication as a social engineering attack

In step 460, the monitoring system may perform one or more remedial actions to mitigate the social engineering attack detected in the first communication. The one or more remedial actions may cause the monitoring system to set a flag indicating that the user is a likely target of a first social engineering attack. In some instances, the one or more remedial actions may be based on the type of social engineering attack. For example, an attempted account takeover may trigger multi-factor authentication. In this regard, a user who was the target of the account takeover may have to enter a one-time code the next time that the user attempts to login to their account or conducts a transaction. The one-time code may be sent (e.g., transmitted), by a server, to a user device. Additionally or alternatively, the one-time code may be generated using a code generator, similar to Google Authenticator. In some instances, the user may not be aware that they are a target of a social engineering attack. Rather, the monitoring system may receive an indication from a merchant that the user would like to conduct a transaction. The monitoring system may send a one-time code to the user device. The transaction may be approved, for example, if the monitoring system receives the one-time code sent to the user device. Conversely, the transaction may be declined if the monitoring system fails to receive the one-time code from the merchant. In another example, the social engineering attack may be an attempt to obtain information from a chatbot or an agent. As part of the remedial actions, the monitoring system may disable at least a portion of a functionality of the chatbot to remediate the first social engineering attack, such as disabling further responses from the chatbot. Additionally or alternatively, the monitoring system may cause the chatbot to stonewall an attacker. For instance, the chatbot may respond with vague and/or unhelpful answers (e.g., “I do not understand your request;” “I am sorry, I cannot provide the information you requested;” etc.). Additionally or alternatively, the chatbot may redirect the attacker to an agent (e.g., a customer service representative). In some examples, the chatbot may initiate a phone call or video conference as part of redirecting the attacker to an agent. In some instances, the system may cause a notification to be displayed to an agent. The notification may indicate the possibility of a social engineering attack.

In step 470, the monitoring system may determine if a plurality of users is subject to social engineering attacks. Additionally or alternatively, the monitoring system may determine whether a network infrastructure is subject to a coordinated cyberattack. In this regard, the social engineering attack may be one aspect of the coordinated cyberattack. If the network infrastructure is not being subjected to a coordinated cyberattack, the monitoring system may return to step 410, and the process 400 may repeat. In this regard, process 400 repeating may include evaluating additional communications that have subsequently been received. However, if the monitoring system determines that the network infrastructure is subject to a coordinated cyberattack, the monitoring system may proceed to step 480.

In step 480, the monitoring system may implement additional security measures, for example, in response to determining that the network infrastructure is subject to a coordinated cyberattack. The additional security measures may be implemented using a second machine learning model, different from the first machine learning model. In some instance, the second machine learning model may comprise a machine learning model configured and/or trained to identify fraud. In response to determining that the network infrastructure is subject to a coordinated cyberattack, the monitoring system may adjust one or more weights of the second machine learning model. Adjusting the one or more weights of the second machine learning model may lower the threshold for detecting fraud and/or provide additional scrutiny to interactions, such as login attempts, password changes, password resets, transactions, etc. As noted above, the additional security measures may comprise enabling multi-factor authentication. Multi-factor authentication may be implemented for all users. Alternatively, multi-factor authentication and/or the additional security measures may be implemented to those users impacted by the coordinated cybersecurity attack and/or the social engineering attack.

Using the techniques described above, the present disclosure allows for the machine learning models to detect (e.g., identify) social engineering attacks in one or more communication channels. By using generative artificial intelligence to generate training data, the present disclosure is able to recognize social engineering attacks. Moreover, remedial actions can be taken to mitigate detected social engineering attacks. The techniques described herein improve computers and/or machine learning model's comprehension to allow the machine learning model to recognize and prevent social engineering attacks.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
detecting, using a machine learning model trained to identify social engineering attacks, a first social engineering attack in a first communication of one or more communications;
based on detecting the first social engineering attack, implementing, using a second machine learning model, security measures for one or more users impacted by the first social engineering attack;
receiving, from a merchant, a request for a transaction from a first user impacted by the first social engineering attack;
determining, using the second machine learning model, whether to apply the security measures; and
based on a determination to apply the security measures, sending, to a first device associated with the first user, authentication parameters.

2. The method of claim 1, wherein the authentication parameters comprise a one-time code, wherein the method further comprises:
receiving, from the merchant, the one-time code; and
based on receiving the one-time code from the merchant, authorizing the transaction.

3. The method of claim 1, further comprising:
providing, to a generative artificial intelligence model, a prompt to generate one or more second communications associated with social engineering attacks;
receiving, based on the prompt, the one or more second communications associated with social engineering attacks; and
inputting the one or more second communications associated with social engineering attacks to the machine learning model to train the machine learning model to identify social engineering attacks.

4. The method of claim 1, wherein detecting the first social engineering attack comprises:
analyzing, using the trained machine learning model, the first communication;
Ip, wherein the probability value indicates a likelihood that the first communication comprises a social engineering attack; and
based on a determination that the probability value exceeds a threshold, identifying the first communication as a social engineering attack.

5. The method of claim 1, further comprising:
based on detecting of the first social engineering attack, adjusting one or more weights of a fraud model.

6. The method of claim 1, wherein a party to the first communication comprises a chatbot, wherein the method further comprises disabling at least a portion of a functionality of the chatbot to remediate the first social engineering attack.

7. The method of claim 6, wherein disabling at least a portion of the functionality of the chatbot comprises disabling further responses from the chatbot.

8. The method of claim 1, wherein a first party to the first communication comprises a chatbot, wherein the method further comprises sending a second party to the first communication to a user service representative.

9. A computing device comprising:
one or more processors; and
memory storing instructions that, when executed by the one or more processors, cause the computing device to:
provide, to a generative artificial intelligence model, a prompt to generate communications associated with social engineering attacks;
receive, based on the prompt provided to the generative artificial intelligence model, one or more communications associated with social engineering attacks; and
input the one or more communications associated with social engineering attacks to a machine learning model to train the machine learning model to detect social engineering attacks;
monitor, using the machine learning model, one or more communication channels;
detect, using the machine learning model, a first social engineering attack in a first communication of the one or more communications received via the one or more communication channels; and
perform, based on detecting the first social engineering attack in the first communication, one or more remedial actions.

10. The computing device of claim 9, wherein the one or more remedial actions comprises requiring multi-factor authentication in order to access accounts associated with one or more users impacted by the first social engineering attack.

11. The computing device of claim 9, wherein the one or more remedial actions comprises flagging, based on a determination that a user is compromised, the user as a likely target of the first social engineering attack.

12. The computing device of claim 9, wherein the instructions, when executed by the one or more processors, cause the computing device to detect the first social engineering attack by:
calculating a probability that the first communication is a social engineering attack; and
determining, based on the probability satisfying a threshold, that the first communication is the first social engineering attack.

13. The computing device of claim 12, wherein the instructions, when executed by the one or more processors, cause the computing device to determine that the first communication is the first social engineering attack by:
determining a geographic location from which the first communication originated; and
assigning, based on the geographic location from which the first communication originated, a risk score, wherein the risk score is used to calculate the probability.

14. The computing device of claim 12, wherein the instructions, when executed by the one or more processors, cause the computing device to determine that the first communication is the first social engineering attack by:
determining, based on a determination that the first communication is associated with a first account, whether a request for a transaction outside of a geographic location associated with the first account has been received; and
assigning, based on a determination that a request for a transaction outside of a geographic location associated with the first account has been received, a risk score, wherein the risk score is used to calculate the probability.

15. The computing device of claim 9, wherein the first communication comprises a plurality of exchanged messages.

16. The computing device of claim 9, wherein the one or more communication channels comprise at least one of conversations with a chatbot, emails, or telephone calls.

17. A non-transitory computer readable medium comprising instructions that, when executed, cause a computing device to:
detect, using a machine learning model trained to identify social engineering attacks, a first social engineering attack in a first communication of one or more communications;
implement, based on detecting the first social engineering attack, security measures for one or more users impacted by the first social engineering attack;
receive, from a merchant, a request for a transaction from a first user impacted by the first social engineering attack;
send, to a device associated with the first user, a one-time code;
receive, from the merchant, the one-time code; and
authorizing, based on receiving the one-time code, the transaction.

18. The non-transitory computer readable medium of claim 17, wherein the instructions, when executed, cause the computing device to:
receive a request to access an account associated with a second user;
request, based on implementing the security measures for one or more users impacted by the first social engineering attack, a secondary authentication credential; and
providing, based on receiving the secondary authentication credential, access to the account associated with the second user.

19. The non-transitory computer readable medium of claim 17, wherein the instructions, when executed, cause the computing device to:
receive a request to access an account associated with a second user;
request, based on implementing the security measures for one or more users impacted by the first social engineering attack, a secondary authentication credential from the second user; and
denying, based on not receiving the secondary authentication credential, access to the account associated with the second user.

20. The non-transitory computer readable medium of claim 17, wherein the instructions, when executed, cause the computing device to:
provide, to a generative artificial intelligence model, a prompt to generate one or more second communications associated with social engineering attacks;
receive, based on the prompt, the one or more second communications associated with social engineering attacks; and
input the one or more second communications associated with social engineering attacks to the machine learning model to train the machine learning model to identify social engineering attacks.
